(19) United States
(12) Patent Application Publication
(10) Pub. No.: US 2012/0323650 A1
(43) Pub. Date: Dec. 20, 2012

(54) Vending Machine For Lipstick And Other Cosmetics

(76) Inventors: Gina M. Blaze, Easton, CT (US); Alice J. Shaw, Sioux Falls, SD (US); Daniel J. Reens, Trumbull, CT (US)

(21) Appl. No.: 13/526,144

(22) Filed: Jun. 18, 2012

Related U.S. Application Data
(60) Provisional application No. 61/497,777, filed on Jun. 16, 2011.

(51) Int. Cl. G06Q 30/02; G06Q 10/08

(52) U.S. Cl. 705/14.4

(57) ABSTRACT

System for distributing products and advertising including a vending machine having a selection of lipsticks and/or other cosmetics as well as an electronic advertisement display, electronic payment acceptance, and communication with the Internet for updating the advertising, relaying inventory status, and validating payment.

### CROSS-REFERENCE TO RELATED APPLICATIONS

This patent application claims the benefit of, under Title 35, United States Code, Section 119(e), U.S. Provisional Patent Application No. 61/497,777, filed Jun. 16, 2011, the content of which is incorporated herein by reference in its entirety.

### FIELD OF THE INVENTION

This invention relates to the field of vending machines, and to vending machines for lipstick and other cosmetics in particular.

### BACKGROUND OF THE INVENTION

Vending machines have long been used for selling various types of commodities and personal effects. In addition to revenues realized from the sale of the contents of a vending machine, additional revenues can be generated through the sale of advertising space on the vending unit itself.

Advertisements featured on vending machines are typically of a static character, and are limited by the colors and materials available for applying a two-dimensional picture to the unit. This can limit the appeal of the vending machine as a vehicle for advertising.

Advertisements featured on vending machines can also become outdated before such time as they can be changed to a new advertisement. Furthermore, disruptions in servicing the machine can result in free advertising for the sponsor who is then disincentivized to renew their campaign in a timely way, resulting in unrealized potential fees. The inability to change the advertising quickly also limits the size and number of time-slots available for sale to advertisers, reducing flexibility in pricing and sales.

The inventory of popular vending machines can be depleted by customers well before the machines are due to be re-stocked. This can lead to significant lost revenue during the period within which the inventory is depleted, as well as a loss of repeat customers due to frustration with a machine that is chronically empty.

Vending machines of the past have typically been of a utilitarian character and disposed in unglamorous locations. However, consumers are most conscious of the need for cosmetic products in locations calling for more impressive or formal dress, such as restaurants, stadiums, and the like. Often, the physical structure and look of vending machines is incompatible with, or inappropriate for these locations, relegating them to other locations, and resulting in missed sales, missed opportunities for customer development, and missed opportunities to associate the product with desirable social settings and demographics.

Vending machines for the sale of small personal effects typically require payment in the form of coins or paper currency. This can be a particular problem in the sale of lipstick and other cosmetics, in that often when in formal settings calling for cosmetics, consumers are attired in such a way, that limits the amount of cash they can carry, Personal security can also be a factor limiting the amount of cash on a consumer's person in the evening, when many social occasions occur.

What is desired therefore is a vending machine for lipstick and other cosmetics that addresses these deficiencies.

### SUMMARY OF THE INVENTION

It is an object of the invention to provide a vending machine for the sale of cosmetics which communicates information via the internet.

It is another object of the present invention to provide a vending machine for the sale of cosmetics which provides means for electronic advertising display.

It is a further object of the present invention to provide a vending machine for the sale of cosmetics which accepts electronic payment, such as by swiping and validating a credit card.

It is yet another object of the invention to provide a vending machine for the sale of cosmetics which provides means for communicating inventory status to a remote location via the internet. In some embodiments, the inventory status contains detail broken out by color or variety.

It is yet a further object of the invention to provide a vending machine for the sale of cosmetics which provides means for remotely changing the content of the electronic advertising display via the internet.

It is still another object of the invention to provide a vending machine for the sale of cosmetics which provides a variety of color, brand, or logo selections for lipsticks or other cosmetics.

In one embodiment, a product and advertising distribution system includes a vending machine having a first processor; a network; a first communications link between the vending machine and the network; a display connected to the vending machine; data storage connected to the vending machine; software executing on the vending machine for displaying an advertisement on the display; software executing on the vending machine for receiving advertising data over the network; and, software executing on the vending machine for transmitting inventory status over the network.

In some embodiments, the system includes a control server having a second processor; a second communications link between the control server and the internet; software executing on the control server for receiving the inventory status over the network; and, software executing on the control server for transmitting the advertising data to the vending machine over the network.

In some embodiments, the system includes software executing on the control server for selecting advertising data to transmit to the vending machine based on the inventory status. Optionally, the advertising data contains an advertisement and/or configuration information for an advertisement. Optionally, the advertising data contains instructions to display an advertisement or a sequence of advertisements. Optionally, the advertisement or sequence of advertisements displayed is selected based upon the inventory data.

In some embodiments, the system includes software executing on the vending machine for transmitting payment information to the control server from the vending machine.

In some embodiments, the system includes software executing on the control server for transmitting pricing information to the vending machine.

In some embodiments, the system includes software executing on the control server for selecting advertising data to transmit to the vending machine based upon the inventory status.

In some embodiments, the system includes software executing on the control server for transmitting a restocking request based upon the inventory status.

In some embodiments, the system includes software executing on the vending machine for selecting an advertisement and displaying the selected advertisement on the display based on the inventory status. Optionally, the data storage contains at least two advertisements, and the advertisement displayed is selected from the advertisements in the data storage based upon the inventory data. Optionally, the data storage contains at least two advertisements, and a sequence of displayed advertisements selected from the advertisements in the data storage is determined based upon the inventory data.

In some embodiments, the system includes software executing on the vending machine for receiving payment information from the user.

In some embodiments, the system includes software executing on the vending machine for transmitting a restocking request based upon the inventory status.

In some embodiments, the system includes a storage device connectable to the vending machine; software executing on the vending machine for storing inventory status on the storage device; and, software executing on the vending machine for downloading advertising data from the storage device.

Other objects of the invention and its particular features and advantages will become more apparent from consideration of the following drawings and accompanying detailed description.

### BRIEF DESCRIPTION OF THE DRAWINGS

FIG. 1 is a perspective view of an example cosmetics vending machine illustrating aspects of the invention.

FIG. 2 is a side view of an example cosmetics vending machine illustrating aspects of the invention.

FIG. 3 is a diagram of an example system for product and advertising distribution illustrating aspects of the invention.

FIG. 4 is a diagram of another example system for product and advertising distribution illustrating aspects of the invention.

### DETAILED DESCRIPTION OF THE INVENTION

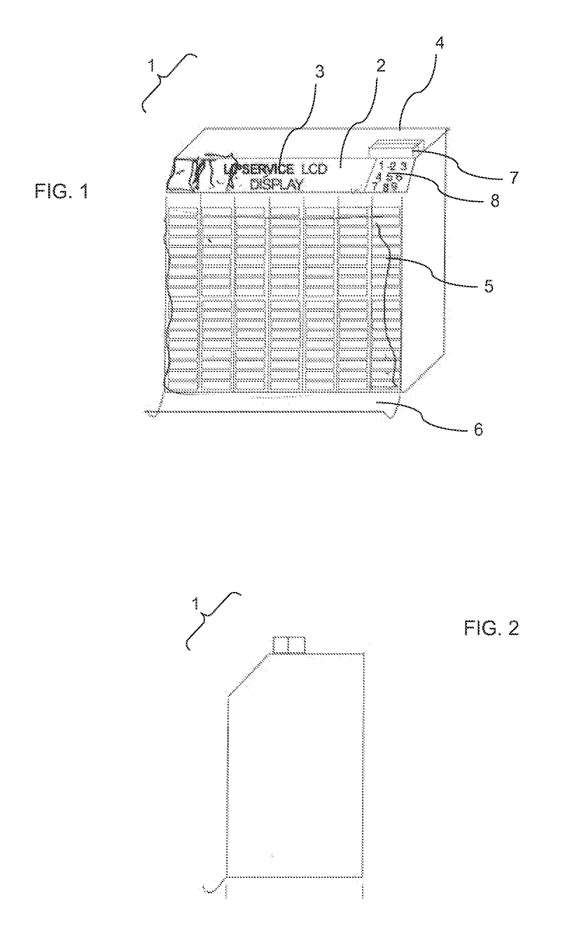

FIGS. 1 and 2 are a perspective view and a side view of a cosmetics vending machine 1 having an electronic display 2 which can be used for the presentation of advertisements 3, a means for electronic payment 4, a cosmetics selection 5 and a dispenser 6.

Vending machine 1 can be powered by standard 120V wall current (not shown) or any other suitable power supply (not shown). In some embodiments, vending machine 1 is tamper-resistant and has a total fully-stocked weight that does not exceed 50 lbs.

Electronic display 2 can comprise a liquid crystal display (LCD), light emitting diode (LED) display, or any other suitable electronic display. Electronic display 2 is supported by all necessary circuitry (not shown) for its operation as well as for communication via the internet (not shown).

Advertisements 3 can comprise text and/or graphics, and can be static or moving images, or any other types of electronic images commonly used in advertising (not shown). Advertisements 3 are supported by all necessary circuitry (not shown) for operation as well as for communication and updating via the internet (not shown).

Means for electronic payment 4 can accept a credit card, debit card, gift card, or other suitable electronic form of payment, and can comprise a card swipe 7 and/or a keypad 8 for the input of additional credentials or other information. In some embodiments, means for electronic payment 4 can comprise an RFID or proximity card reader, or any other credential reader known in the art (not shown). Means for electronic payment 4 is supported by all necessary circuitry (not shown) for its operation as well as for communication via the internet (not shown). In alternative embodiments, means for electronic payment 4 can be supplemented by a means for cash payment (not shown).

In a preferred embodiment, cosmetics selection 5 comprises a selection of several shades of lipsticks representing the most popular shade for each major complexion type (not shown). In some embodiments, cosmetics selection 5 comprises a quantity of 50 each of 7 different types of lipstick for a total of 350 lipsticks (not shown). The inventory (not shown) of cosmetics selection 5 is tracked and supported by all necessary circuitry (not shown) for its operation, as well as for communication of inventory status via the internet (not shown).

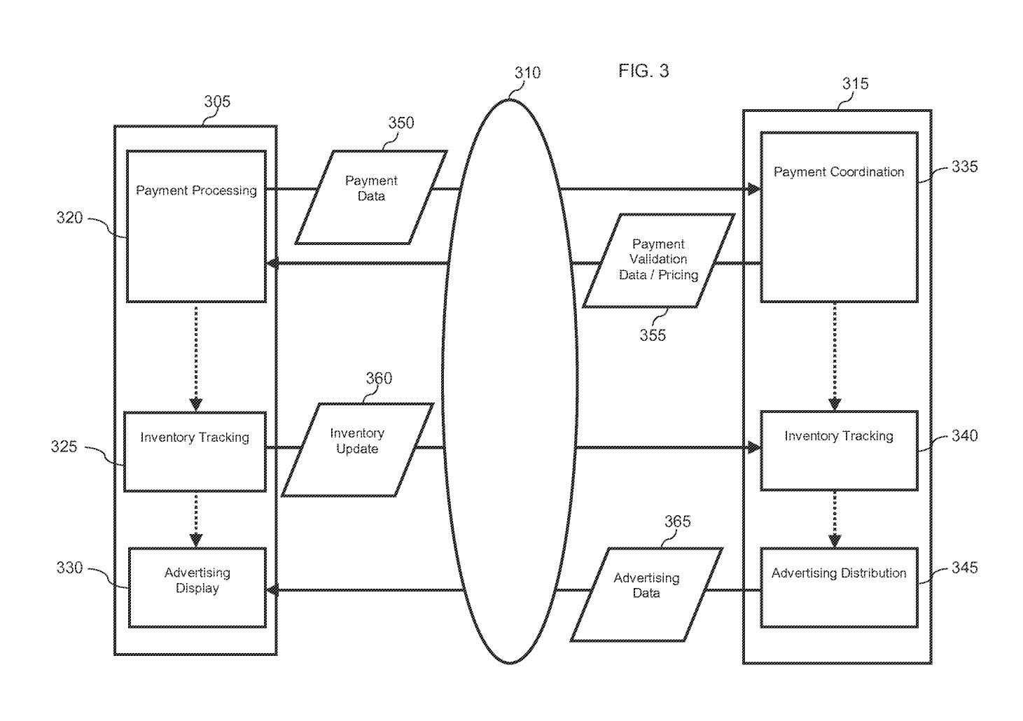

FIG. 3 is a schematic diagram of an example system incorporating remote server control, which illustrates aspects of the invention.

Vending machine 305 is substantially similar to vending machine 1 described herein with respect to FIGS. 1 and 2. Vending machine 305 is connected to a network 310 using a wired or wireless communications link. Network 310 may be the Internet, a subset of the internet, LAN, WAN, WIFI or mobile network, another computer communications network, or combinations of any of these networks. A control server 315 is also connected to network 310 using a wired or wireless communications link, and is in communication with vending machine 305 over network 310. Optionally, control server 315 may control more than one vending machine (not shown). Examples of typical arrangements are a remote server communicating with vending machine 305 over the internet, a laptop communicating with vending machine 305 over a local WIFI network, or a server application running on a smart phone communicating with vending machine 305 over a mobile communications network. Those having skill in the art will appreciate that various other permutations and combinations of these types of hardware are possible.

Vending machine 305 includes a payment processing function 320, inventory tracking function 325, and advertising display function 330. Each of these includes all necessary hardware and circuitry for carrying out its function, and may include a processor, memory, and software executing on the processor for carrying out the function.

Control server 315 includes a payment control function 335, inventory tracking function 340, and an advertising distribution function 345. Each of these functions includes all necessary hardware and circuitry for carrying out its function, and may include a processor, memory, and software executing on the processor for carrying out the function. Vending machine 305 is in communication with control server 315 over network 310.

Payment processing function 320 may include a card swipe mechanism, keypad, proximity or RFID sensor, bill acceptor, or other structure for obtaining cash or electronic payment for merchandise from a customer (not shown). When a user presents payment to vending machine 305, payment processing function 320 transmits payment data 350 to payment control function 335. Payment data 350 may include credit card information, for example, or may contain other information, such as a total amount of cash. In the case of credit or debit card payment, payment control function 335 operates to validate this information with the appropriate financial institution, and transmits payment validation data 355 to payment processing function 320. Payment validation data 355 includes information authorizing or declining the use of the credit or debit card information for payment. In all cases, payment control function 335 can store or transmit the payment amount for further processing. Alternatively, vending machine 305 may be in direct communication with a financial institution for payment authorization.

Optionally, payment processing function 305 may receive pricing updates from payment coordination function 335.

Inventory tracking function 325 keeps track of the number and types of product in vending machine 305. When the user successfully purchases a product, inventory tracking function 325 updates the inventory status and transmits inventory update data 360 information to inventory tracking function 340. Optionally, inventory tracking function 340 can request an update from inventory tracking function 325 at an arbitrary time. Optionally, inventory tracking function 325 can transmit inventory update data 360 to inventory tracking function 340 on a periodic basis, or upon the occurrence of a particular event such as complete depletion of the inventory stock or relative depletion of one or more items as compared to other items of the inventory stock. Inventory tracking function 340 may also alternatively derive inventory information from payment processing function 335 without the need for a separate communication of inventory update data 360. Inventory tracking function 325 may likewise derive inventory information from payment processing function 320 without the need for a fully discrete subsystem of inventory monitoring hardware. For example, starting from a complete stock, the inventory number can simply be decremented with each successful purchase rather than sensing the stock directly.

Advertising display function 330 may include one or more electronic displays such as an LED, OLED, or LCD display panel, or another device which can show still or moving images (not shown). Optionally, advertising display function 330 also incorporates a speaker or other sound reproduction means. Advertising display function 330 may contain a number of advertisements stored in memory, which can be displayed alternately or simultaneously on one or more display panels (not shown) and may optionally incorporate audio.

Advertising display function 330 can be updated with new advertising data 365 by advertising distribution function 345.

Advertising distribution function 345 may transmit advertising data 365 to advertising display function 330 on a periodic basis, upon the occurrence of a particular event such as the availability of new sponsorship, complete depletion of the inventory stock, or relative depletion of one or more items as compared to other items of the inventory stock. Optionally, advertising distribution function 345 may query advertising display function 330 to determine which advertisements if any are resident and/or displayed.

Advertising data 365 may include one or more advertisements to be displayed or stored for display by advertising display function 330. Advertising data 365 may also include configuration data for advertising display function 330, which controls other functionality relating to the advertisements. The configuration data may include instructions for advertisement scheduling, controlling which advertisements are displayed at what times or in response to which events. For example, advertising data 365 might include a new advertisement for a particular brand of lipstick, and configuration data directing advertising display function 330 to present this advertisement, or increase its frequency in a rotation of several advertisements. In another example, advertising data 365 may include instructions to delete some advertisements from advertising display function 330, or to schedule advertisements already resident in advertising display function 330.

Advertising display function 330 may also optionally derive inventory information from inventory tracking function 325 without the need for a separate communication of advertising data 360. Advertising display section 330 can use information from the inventory tracking function 325 to schedule the display of advertisements. For example, when the stock of this particular brand of lipstick is greater within the machine relative to other brands, an advertisement for that brand may be displayed, or its frequency of display may be increased in a rotation of several advertisements. Conversely, advertisements for sold out brands can be curtailed. This can have the advantage of optimizing sales of items in stock or achieving other goals of an advertising campaign.

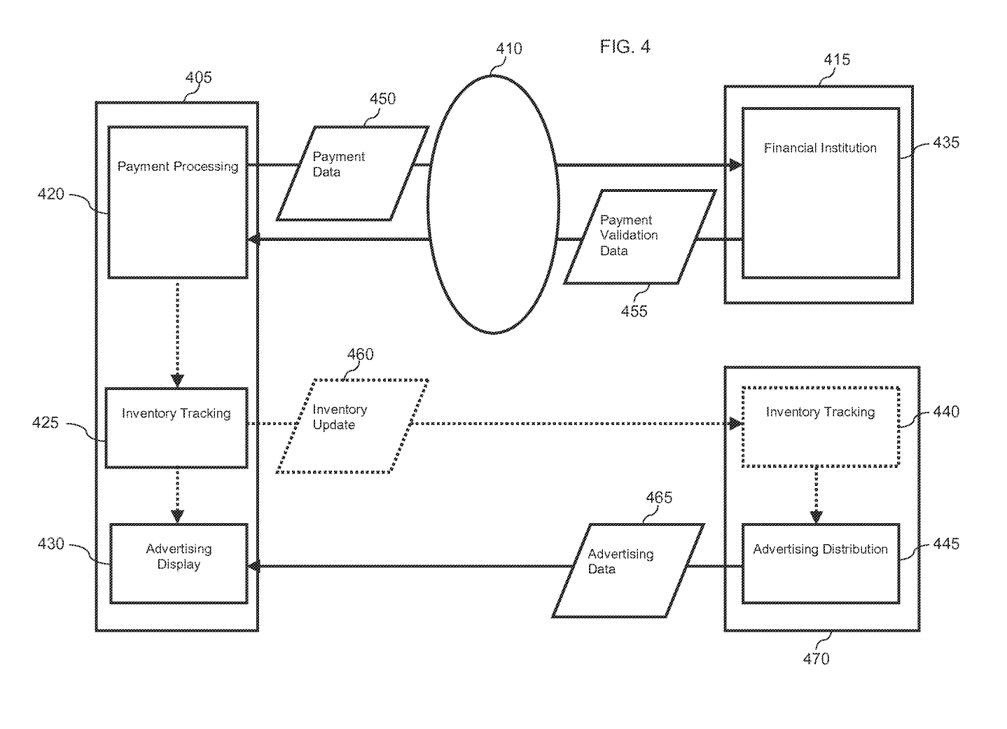

FIG. 4 is a schematic diagram of an example system incorporating local control, which illustrates aspects of the invention.

Vending machine 405 is substantially similar to vending machine 1 described herein with respect to FIGS. 1 and 2. Vending machine 405 is connected to a network 410 using a wired or wireless communications link. Network 410 may be the Internet, a subset of the internet, LAN, WAN, WIFI or mobile network, another computer communications network, or combinations of any of these networks. Financial institution server 435 is also connected to network 410 using a wired or wireless communications link, and is in communication with vending machine 405 over network 410.

Vending machine 405 includes a payment processing function 420, inventory tracking function 425, and advertising display function 430. Each of these includes all necessary hardware and circuitry for carrying out its function, and may include a processor, memory, and software executing on the processor for carrying out the function.

Financial institution server 435 is operated by a financial institution 415 or other entity for validating payment information. Each of Financial institution server 435 contains all necessary hardware and circuitry for carrying out its function, and may include a processor, memory, and software executing on the processor for carrying out the function. Vending machine 405 is in communication with financial institution server 435 over network 410.

Payment processing function 420 may include a card swipe mechanism, keypad, proximity or RFID sensor, bill acceptor, or other structure for obtaining cash or electronic payment for merchandise from a customer (not shown). When a user presents payment to vending machine 405, payment processing function 420 transmits payment data 450 to payment control function 435. Payment data 450 may include credit card information, for example, or may contain other information, such as a total amount of cash. In the case of credit or debit card payment, payment control function 435 operates to validate this information with the appropriate financial institution, and transmits payment validation data 455 to payment processing function 420. Payment validation data 455 includes information authorizing or declining the use of the credit or debit card information for payment. In all cases, payment control function 435 can store or transmit the payment amount for further processing.

Local control system 470 is connectable to vending machine 405 and implements an advertising distribution function 445 and optionally implements an inventory tracking function 440. Local control system 470 contains all necessary hardware and circuitry for carrying out its function, and may include a processor, memory, and software executing on the processor for carrying out the function. Local control system 470 may be a laptop computer, smart phone, USB memory stick, or other computing device or storage medium.

Inventory tracking function 425 keeps track of the number and types of product in vending machine 405. When the user successfully purchases a product, inventory tracking function 425 updates the inventory status and optionally may transmit inventory update data 460 information to inventory tracking function 440. Optionally, inventory tracking function 440 can request an update from inventory tracking function 425 at an arbitrary time. Optionally, inventory tracking function 425 can transmit inventory update data 460 to inventory tracking function 440 on a periodic basis, or upon the occurrence of a particular event such as complete depletion of the inventory stock, relative depletion of one or more items as compared to other items of the inventory stock, connection of local control system 470 to vending machine 405, or a combination of any of these events. Inventory tracking function 440 may also alternatively derive inventory information from payment processing function 420 without the need for a separate communication of inventory update data 460. Inventory tracking function 425 may likewise derive inventory information from payment processing function 420 without the need for a fully discrete subsystem of inventory monitoring hardware. For example, starting from a complete stock, the inventory number can simply be decremented with each successful purchase rather than sensing the stock directly.

Advertising display function 430 may include one or more electronic displays such as an LED, OLED, or LCD display panel, or another device which can show still or moving images (not shown). Optionally, advertising display function 430 also incorporates a speaker or other sound reproduction means. Advertising display function 430 may contain a number of advertisements stored in memory, which can be displayed alternately or simultaneously on one or more display panels (not shown) and may optionally incorporate audio.

Advertising display function 430 can be updated with new advertising data 465 by advertising distribution function 445.

Advertising distribution function 445 may transmit advertising data 465 to advertising display function 430 on a periodic basis, upon the occurrence of a particular event such as the availability of new sponsorship, complete depletion of the inventory stock, relative depletion of one or more items as compared to other items of the inventory stock, connection of local control system 470 to vending machine 405, or a combination of any of these events. Optionally, advertising distribution function 445 may query advertising display function 430 to determine which advertisements if any are resident and/or displayed.

Advertising data 465 may include one or more advertisements to be displayed or stored for display by advertising display function 430. Advertising data 465 may also include configuration data for advertising display function 430, which controls other functionality relating to the advertisements. The configuration data may include instructions for advertisement scheduling, controlling which advertisements are displayed at what times or in response to which events. For example, advertising data 465 might include a new advertisement for a particular brand of lipstick, and configuration data directing advertising display function 430 to present this advertisement, or increase its frequency in a rotation of several advertisements. In another example, advertising data 465 may include instructions to delete some advertisements from advertising display function 430, or to schedule advertisements already resident in advertising display function 430.

Advertising display function 430 may also optionally derive inventory information from inventory tracking function 425 without the need for a separate communication of advertising data 460. Advertising display section 430 can use information from the inventory tracking function 425 to schedule the display of advertisements. For example, when the stock of this particular brand of lipstick is greater within the machine relative to other brands, an advertisement for that brand may be displayed, or its frequency of display may be increased in a rotation of several advertisements. Conversely, advertisements for sold out brands can be curtailed. This can have the advantage of optimizing sales of items in stock or achieving other goals of an advertising campaign.

Although the invention has been described with reference to a particular arrangement of parts, features and the like, these are not intended to exhaust all possible arrangements or features, and indeed many modifications and variations will be ascertainable to those of skill in the art.

What is claimed is:

1. A product and advertising distribution system comprising:
a vending machine having a first processor;
a network;
a first communications link between the vending machine and the network;
a display connected to the vending machine;
data storage connected to the vending machine;
software executing on the vending machine for displaying an advertisement on the display;
software executing on the vending machine for receiving advertising data over the network; and,
software executing on the vending machine for transmitting inventory status over the network.

2. The product and advertising distribution system of claim 1, further comprising:
a control server having a second processor;
a second communications link between the control server and the internet;
software executing on the control server for receiving the inventory status over the network; and,
software executing on the control server for transmitting the advertising data to the vending machine over the network.

3. The product and advertising distribution system of claim 1, further comprising:
software executing on the vending machine for selecting an advertisement and displaying the selected advertisement on the display based on the inventory status.

4. The product and advertising distribution system of claim 2, further comprising:
software executing on the control server for selecting advertising data to transmit to the vending machine based on the inventory status.

5. The product and advertising distribution system of claim 4, wherein the advertising data contains an advertisement.

6. The product and advertising distribution system of claim 4, wherein the advertising data contains configuration information for an advertisement.

7. The product and advertising distribution system of claim 6, wherein the configuration information contains instructions to display an advertisement.

8. The product and advertising distribution system of claim 6, wherein the configuration information contains instructions to display a sequence of advertisements.

9. The product and advertising distribution system of claim 7, wherein the advertisement displayed is selected based upon the inventory data.

10. The product and advertising distribution system of claim 8, wherein the sequence of advertisements is determined based upon the inventory data.

11. The product and advertising distribution system of claim 1, wherein the data storage contains at least two advertisements, and the advertisement displayed is selected from the advertisements in the data storage based upon the inventory data.

12. The product and advertising distribution system of claim 1, wherein the data storage contains at least two advertisements, and a sequence of displayed advertisements selected from the advertisements in the data storage is determined based upon the inventory data.

13. The product and advertising distribution system of claim 1, further comprising:
software executing on the vending machine for receiving payment information from the user.

14. The product and advertising distribution system of claim 2, further comprising:
software executing on the vending machine for transmitting payment information to the control server from the vending machine.

15. The product and advertising distribution system of claim 2, further comprising:
software executing on the control server for transmitting pricing information to the vending machine.

16. The product and advertising distribution system of claim 2, further comprising:
software executing on the control server for selecting advertising data to transmit to the vending machine based upon the inventory status.

17. The product and advertising distribution system of claim 2, further comprising:
software executing on the control server for transmitting a restocking request based upon the inventory status.

18. The product and advertising distribution system of aim 1, further comprising:
software executing on the vending machine for transmitting a restocking request based upon the inventory status.

19. The product and advertising distribution system of claim 2, further comprising:
software executing on the control server for transmitting a restocking request based upon the inventory status.

20. The product and advertising distribution system of claim 1, further comprising:
a storage device connectable to the vending machine;
software executing on the vending machine for storing inventory status on the storage device; and,
software executing on the vending machine for downloading advertising data from the storage device.
